(19) United States
(12) Patent Application Publication
(10) Pub. No.: US 2017/0371076 A1
(43) Pub. Date: Dec. 28, 2017

(54) MULTIFOCAL OPTICAL SYSTEM, METHODS, AND APPLICATIONS

(71) Applicant: Arizona Board of Regents on Behalf of the University of Arizona, Tucson, AZ (US)

(72) Inventors: Hong Hua, Tucson, AZ (US); Yi Qin, Tucson, AZ (US)

(73) Assignee: Arizona Board of Regents on Behalf of the University of Arizona, Tucson, AZ (US)

(21) Appl. No.: 15/631,760

(22) Filed: Jun. 23, 2017

Related U.S. Application Data
(60) Provisional application No. 62/355,647, filed on Jun. 28, 2016.

(51) Int. Cl. G02B 3/10; G02F 1/1335; G02F 1/29

(52) U.S. Cl. CPC G02B 3/10; G02F 1/29; G02F 1/133526; G02F 2001/294

(57) ABSTRACT

A digitally programmable multifocal optics method of selectively focusing incident light at a plurality of focal points along an optical axis. A multifocal system that enables selective focusing of incident light at a plurality of focal points along an optical axis. A high-speed digital multi-focal optical element includes a multi-focal lens and either a programmable optical shutter array (POSA) or a programmable spatial light modulator (SLM).

### RELATED APPLICATION DATA

The instant application claims priority to U.S. provisional application Ser. 62/355,647 filed Jun. 28, 2016, the subject matter of which is incorporated by reference herein in its entirety.

### GOVERNMENT FUNDING

N/A.

### BACKGROUND

Aspects and embodiments of the invention are in the field of optical systems; more particularly, multifocal optical systems; most particularly, programmable/controllable/tunable multifocal optical systems, associated methods, and applications thereof.

A conventional optical lens has a fixed focal length and optical magnification. A zoom optical system, which involves, e.g., changing the focal length, optical magnification, and focus position, requires the movement of one or more lenses. Moving optical elements mechanically is relatively slow, thus speed is always a limiting factor of a zoom lens/system.

In recent years multifocal and tunable optics technologies encompassing variable focus lenses such as liquid lenses or liquid crystal lenses, have developed rapidly. Such technology enables electrically tuning the optical power of an optical system at high speed without any mechanical movement of the optical components. By changing an input voltage or current, the focal length of the variable focus lens can be changed. This can be realized, e.g., by changing the radius of curvature of an optical surface or the index of refraction of the lens.

Multifocal optics technology has a wide range of applications, from displays to microscopy and more. For instance, to address the well-known accommodation and convergence discrepancy problem in head-mounted display (HMD) systems, several display methods have been explored to approximate the visual effects created by the focus cues when viewing a real-world scene. Reported examples include a vari-focal plane HMD method that dynamically compensates the focal distance of a single-plane display based on a viewer's fixation point; a multi-focal plane (MFP) display method that creates a stack of focal planes in space- or time-multiplexing fashion; and micro-integral imaging (InI) methods that reconstruct the full-parallax lightfields of a 3D scene through a pinhole or lenslet array. Among these methods, a time-multiplexed, depth-fused multi-focal plane (DFD-MFP) method was demonstrated with the capability of rendering correct focus cues for a 3D scene across a large depth volume at high spatial resolution comparable to conventional non-lightfield HMD methods. However, the time-multiplexing nature of this method demands a high-speed (e.g. kHz rate) tunable optical element that is capable of dynamically tuning the optical power in a large dioptric range with a large clear aperture.

The micro-InI based lightfield display approach has also been demonstrated with the ability to render correct focus cues. However, the optical performances of InI displays based on simple lenslet array structures are low and do not yield adequate spatial resolution, depth of field, longitudinal resolution, or viewing angle resolution. Therefore, this approach also requires a multifocal optics architecture to replace a simple lenslet array structure.

These examples clearly demonstrated that multifocal and tunable optics technologies are key enabling technologies for building future high-performance lightfield display systems. State-of-the-art tunable optical technologies, however, are far from being able to meet the challenging requirements for creating high-performance lightfield HMD systems.

Several vari-focal technologies exist, including deformable membrane mirror devices (DMMDs), electrowetting lenses, electrophoretic lenses, elastomer-membrane fluidic lenses, and liquid crystal lenses. In a DFD-MFP prototype system, the inventors utilized two DMMDs (OKO; http://www.okotech.com/) as the tunable optics. Although the speed of the DMMD is adequate for the application, the device suffers from several critical limitations that make the device unsuitable for a wearable system. For example, the reflective nature of the device leads to a much longer optical path length than a refractive device; the clear aperture (˜10 mm) and the range of varying optical power (˜1.2 diopters) are limited, which leads to necessary tradeoffs between tunable depth range and system exit pupil diameter due to the Lagrange invariant constraint; the high driving voltage (˜200 volts) required for the device is inappropriate for a wearable device; and, the active surface is a very thin membrane that is prone to damage.

The inventors also tested several generations of the liquid lens technology based on electrowetting phenomenon by Varioptic Inc. (www.varioptic.com). Although the refractive nature and the large optical power range are highly desirable, the response speed of the liquid lenses is limited to approximately 30-100 Hz and the useful optical aperture is limited to about 2.5-4 mm, which makes them unusable for HMD application.

Another technology that was tested is the electronically tunable lens based on a combination of optical fluids and an elastic polymer membrane by Optotune Inc. (www.optotune.com). This technology affords a large range of tunable power, low voltage control, a desirable refractive nature, and a larger optical aperture (6-16 mm) than the liquid lenses. However, it requires 6-15 ms for settling, making the overall speed inadequate. Additionally, the optical power is sensitive to temperature and to gravity.

None of the commercially available electrically controlled vari-focal technologies meet the requirements of high-speed, large aperture, large range of tunable power, low-voltage control, robustness, and compactness, which are necessary properties for creating a wearable lightfield display solution. Moreover, none of these technologies are readily scalable to create multifocal lenslet arrays that would be further beneficial to a wide range of applications. Developing innovative optical solutions to tunable lens technology offers advantageous benefits for creating high-performance lightfield display systems.

### BRIEF DESCRIPTION OF THE DRAWINGS

FIG. 1A: Optical design of a selectively variable focus element (VFE) including a multi-focal lens and a programmable optical shutter; FIG. 1B Illustration of the independently switchable concentric apertures of the optical shutter, according to an exemplary embodiment of the invention.

FIG. 2: Schematic layout design of a VFE including a multi-focal lens and a remotely disposed but optically conjugate reflective optical shutter device, according to an illustrative embodiment of the invention.

FIG. 3A: Schematic design of vari-focal lenslet array including a multi-focal lens array and a programmable optical shutter array; FIG. 3B Illustration of the independently switchable concentric apertures of the lenslet array, according to an exemplary embodiment of the invention.

FIG. 4: Optical design example of a four-foci segmented lens with the focal lengths increasing from the center to the edge of the lens, according to an exemplary embodiment of the invention.

FIG. 5: Optical design example of a four-foci continuous lens with the focal lengths increasing from the center to the edge of the lens, according to an exemplary embodiment of the invention.

FIG. 6: Optical design example of a four-foci segmented lens with the focal lengths decreasing from the center to the edge of the lens, according to an exemplary embodiment of the invention.

FIG. 7: Optical design example of a four-foci continuous lens with the focal lengths decreasing from the center to the edge of the lens, according to an exemplary embodiment of the invention.

FIGS. 8A-8D: Modulation transfer function of the design shown in FIG. 5: FIG. 8A 140 mm focal length; FIG. 8B 110 mm focal length; FIG. 8C 80 mm, and FIG. 8D 50 mm, according to an illustrative embodiment of the invention.

FIG. 9A shows the optical design layout of a multi-focal lenslet array. Each elemental lens in the array has a diameter of 2 mm and offers three discrete focal lengths of 4 mm, 5 mm, and 6 mm. FIGS. 9B through 9D show the MTFs of the lenslet corresponding to the focal lengths of 4 mm, 5 mm, and 6 mm, respectively, according to an illustrative embodiment of the invention.

### SUMMARY

An aspect of the invention is a digitally programmable multifocal optics method of selectively focusing incident light at a plurality of focal points along an optical axis. A related aspect is a multifocal system that enables selectively focusing incident light at a plurality of focal points along an optical axis. It is to be understood that while the embodied methods and apparatus may be referred to herein as tunable, selectively focusable, and/or multifocal, it is to be understood that the embodied lens assembly can be programmed or otherwise operated to focus light at only a single, or a selective plurality of, focal locations.

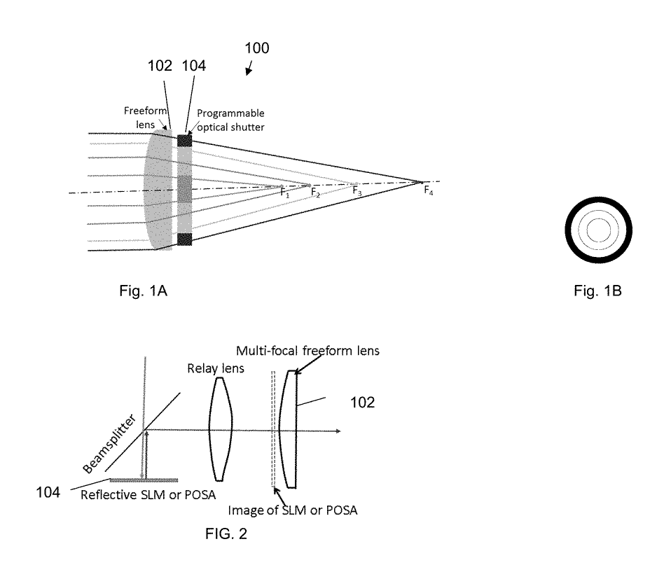

FIG. 1A shows a schematic layout of a high-speed digital multi-focal optical element 100. It includes a multi-focal lens 102 and either a programmable optical shutter array (POSA) 104 or a programmable spatial light modulator (SLM) (hereinafter, ‘programmable shutter’) 104. The lens may or may not be a freeform design. The surface shape of the lens varies such that its optical power depends on the ray height incident on the lens, creating a sequence of distinctive foci (e.g., f₁, f₂, f₃, f₄ etc.). In this embodiment, a POSA 104 is disposed immediately adjacent the lens as illustrated in FIG. 1B. The aperture of the POSA is divided into multiple concentric regions as shown, corresponding to the ray heights and the respective different foci of the lens. The light transmission through each concentric region of the programmable shutter can be independently switched on or off by applying a low voltage, for example. By controlling the optical shutter, allowing the light of one or more ring regions to pass, this lens system can selectively vary its focal length correspondingly. The focal range of this high-speed digital multi-focal optical element is not limited, since a freeform lens, for example, can be customized and fabricated by single point diamond turning or molding. In addition, the number of selectable focal lengths can be customized based on different applications.

The programmable shutter 104 can be either a transmissive device such as, e.g., a liquid crystal (LC) based SLM or a reflective device such as, e,g., a digital mirror device (DMD) or a liquid-crystal on silicon (LCoS) type device. Furthermore, the programmable shutter does not have to be physically adjacent to the lens. Alternatively, it can be optically relayed such that the device is optically next to the aperture of the lens for light transmission control. FIG. 2 illustrates an example of an optical layout using a non-physically adjacent, reflective SLM or POSA for focus control.

Either one or both surfaces of the lens can have an optical power to create a multi-foci element and, e.g., provide optical aberration correction. The lens surface(s) may be continuous or segmented zones without smooth surface continuity.

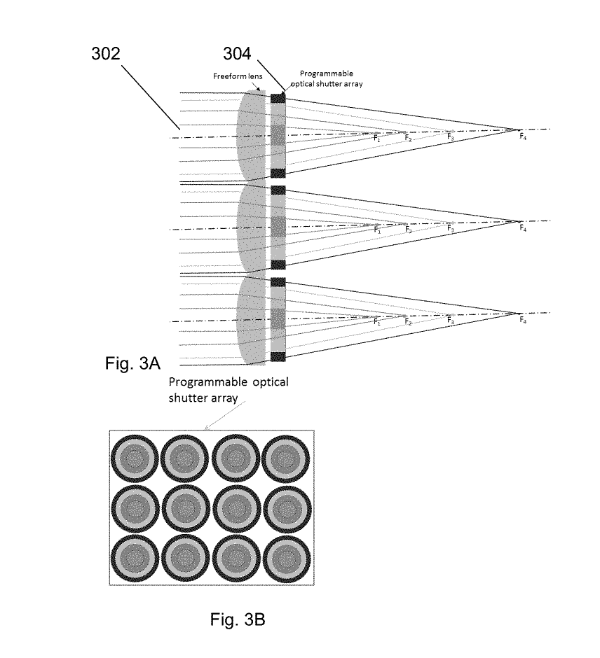

In an alternative embodiment, the lens and programmable shutter assembly may be replaced with a multi-focal lens array element 302 and a corresponding programmable shutter array element 304 as illustrated in FIG. 3A. Each lenslet of the array creates multiple distinctive foci that can be switched by a respective programmable shutter, as illustrated. This architecture ensures that the focus switching is synchronized due to the benefit of pixel-level synchronization of a high-speed programmable shutter. Similar to the single-element case, the programmable shutter can be either transmissive or reflective and may be, but does not have to be physically adjacent to the lenslet array.

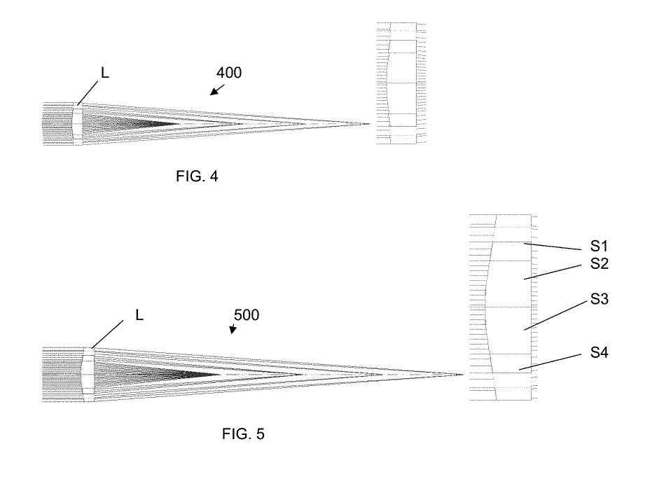

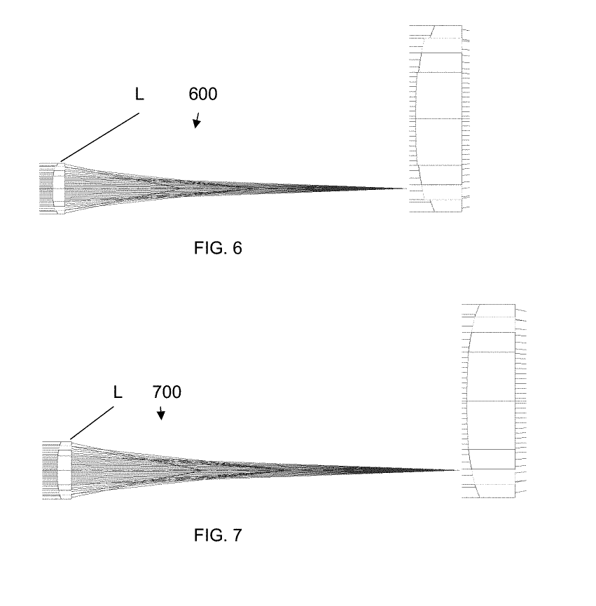

FIG. 4 through FIG. 7 demonstrate four different exemplary designs 400, 500, 600, 700 of a freeform multi-focal optical lens, L, that creates four distinctive foci in the focal range of 50-140 mm with a clear lens aperture of 20 mm in diameter. The discrete focal lengths are f₁=50 mm, f₂=80 mm, f₃=110 mm, and f₄=140 mm. Among the four designs, the designs shown in FIGS. 4 and 6 have a segmented, non-continuous optical surface, while the designs shown in FIGS. 5 and 7 have a continuous optical surface for creating the four discrete foci. The main difference between the designs in FIGS. 4 and 5 from those in FIGS. 6 and 7 lies in the direction of the optical power change. The optical power of the lens shown in FIGS. 4 and 5 decreases from the center of the lens to the edge of the lens, such that the light rays focusing on the four foci of the lens do not cross each other (f₄>f₃>f₂>f₁). The optical power of the lens shown in FIGS. 6 and 7, however, increases from the center of the lens to the edge of the lens, such that the light rays focusing on the four foci of the lens cross each other (f₄≦f₃≦f₂≦f₁).

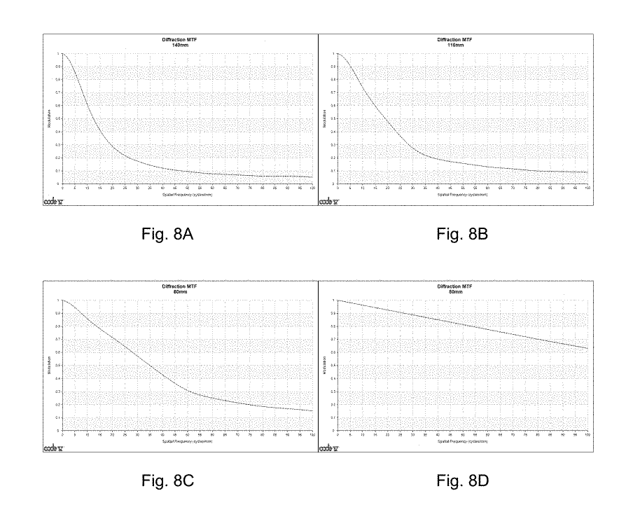

In an exemplary embodiment, the freeform surface of the design 500 shown in FIG. 5 has four segments of aspherical surfaces, S1, S2, S3, and S4, respectively, from the center zone to the edge. Tables 1 through 4 list the optical prescriptions of these surfaces. FIGS. 8A-D show the modulation transfer function of the design, corresponding to the four foci. Each of the surfaces is defined by

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12}$$

where z is the sag of the surface measured along the z-axis of a local x, y, z coordinate system, c is the vertex curvature, r is the radial distance, k is the conic constant, A through E are the 4th, 6th, 8th, 10^{th}, and 12th order deformation coefficients, respectively.

TABLE 1
Surface Prescription for Surface S1

| | |
|---|---|
| Y Radius | 68.84 |
| Conic Constant (K) | 0 |
| 4th Order Coefficient (A) | −2.21e−007 |
| 6th Order Coefficient (B) | −3.51e−011 |
| 8th Order Coefficient (C) | −5.16398e−015 |
| 10th Order Coefficient (D) | −7.84e−019 |
| 12th Order Coefficient (E) | −1.22e−022 |

TABLE 2
Surface Prescription for Surface S2

| | |
|---|---|
| Y Radius | 54.09 |
| Conic Constant (K) | 0 |
| 4th Order Coefficient (A) | −4.56e−007 |
| 6th Order Coefficient (B) | −1.16e−010 |
| 8th Order Coefficient (C) | −2.74e−014 |
| 10th Order Coefficient (D) | −1.58e−017 |
| 12th Order Coefficient (E) | 5.60e−020 |

TABLE 3
Surface Prescription for Surface S3

| | |
|---|---|
| Y Radius | 39.34 |
| Conic Constant (K) | 0 |
| 4th Order Coefficient (A) | −1.18e−006 |
| 6th Order Coefficient (B) | −5.72e−010 |
| 8th Order Coefficient (C) | −2.58e−013 |
| 10th Order Coefficient (D) | −1.23e−016 |
| 12th Order Coefficient (E) | −5.26e−020 |

TABLE 4
Surface Prescription for Surface S4

| | |
|---|---|
| Y Radius | 24.58 |
| Conic Constant (K) | 0 |
| 4th Order Coefficient (A) | −4.82e−006 |
| 6th Order Coefficient (B) | −5.98e−009 |
| 8th Order Coefficient (C) | −7.07e−012 |
| 10th Order Coefficient (D) | −7.33e−015 |
| 12th Order Coefficient (E) | −1.67e−017 |

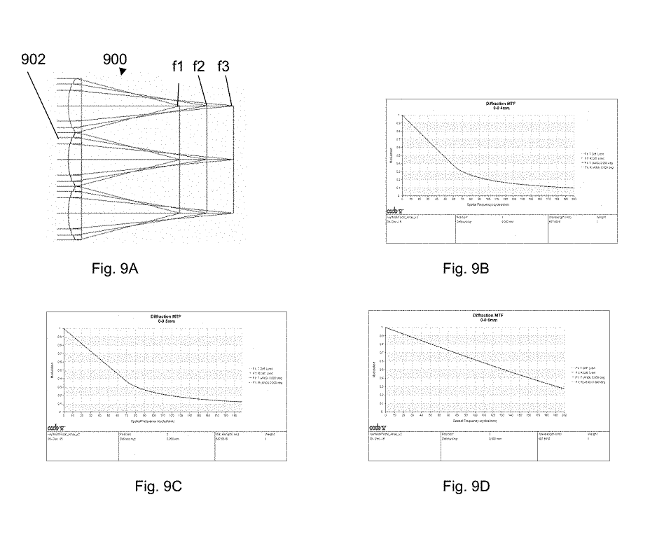

FIG. 9A shows the optical design layout 900 of a multi-focal lenslet array 902. Each elemental lens in the array has a diameter of 2 mm and offers three discrete focal lengths of f₁=4 mm, f₂=5 mm, and f₃=6 mm. In the layout, only three elements are shown as example, but the array can be extended to as many elements as needed. FIGS. 9B through 9D show the MTFs of the lenslet corresponding to the focal lengths of 4 mm, 5 mm, and 6 mm, respectively.

The number of foci, the clear aperture, and the response speed of the proposed approach are not limited by the design of the lens, but by the spatial resolution and the switching speed of the programmable shutter array. In general, the switching speed of our multi-focal technology can be 100 Hz or higher. When high-speed POSA or SLM technologies are utilized, the switching speed can reach 1000 Hz or higher. For instance, the ferroelectric property of chiral smectic liquid crystals offers a bi-state switching time as fast as a few microseconds and has been utilized for high-speed microdisplays and optical switches. When applying this technology or other similar high-speed devices with our freeform lens design, the switching speed of our multi-focal technology can be as high as several thousands of Hz, which will enable a wide range of high-speed display and imaging applications.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

We claim:

1. A multifocal system, comprising:
at least one lens having a plurality of different focal zones; and
at least one respective programmable shutter having a plurality of independently controllable shutter zones corresponding to the plurality of different focal zones, disposed optically adjacent the at least one lens.

2. The multifocal system of claim 1, wherein the at least one respective programmable shutter is disposed immediately adjacent the at least one respective lens.

3. The multifocal system of claim 1, comprising an array of the lenses and a corresponding respective array of programmable shutters.

4. The multifocal system of claim 1, wherein the plurality of different focal zones are on at least one of an anterior surface and a posterior surface of the lens, further wherein the at least one of the anterior surface and the posterior surface is one of a smooth, continuous, uniform surface and a discontinuous, segmented surface.

5. The multifocal system of claim 1, wherein the at least one lens has an anterior surface and a posterior surface, further wherein at least one of the surfaces has a shape such that each focal zone coincides with a ray height incident on the lens.

6. The multifocal system of claim 1, wherein the plurality of independently controllable shutter zones are concentric regions of the at least one programmable shutter.

7. The multifocal system of claim 1, wherein a light transmission characteristic of each of the plurality of independently controllable shutter zones is controlled by an applied voltage.

8. The multifocal system of claim 1, wherein the plurality of different focal zones are each characterized by a focal power that increases in a radially increasing direction.

9. The multifocal system of claim 1, wherein the plurality of different focal zones are each characterized by a focal power that decreases in a radially increasing direction.

10. The multifocal system of claim 1, wherein the at least one respective programmable shutter is a transmissive device.

11. The multifocal system of claim 10, wherein the at least one transmissive programmable shutter is a spatial light modulator.

12. The multifocal system of claim 11, wherein the spatial light modulator comprises a liquid crystal.

13. The multifocal system of claim 1, wherein the at least one respective programmable shutter is a reflective device.

14. The multifocal system of claim 13, wherein the at least one reflective programmable shutter is at least one of a digital mirror device (DMD) and a liquid-crystal on silicon (LCoS) device.

15. The multifocal system of claim 1, characterized by a focal zone switching speed equal to or greater than 100 Hz.

16. The multifocal system of claim 1, wherein the at least one lens is a free-form lens design.

17. A method of focusing incident light at a plurality of focal points along an optical axis, comprising:
providing a multifocal system in the path of the incident light, comprising:
at least one lens having a plurality of different focal zones; and
at least one respective programmable shutter having a plurality of independently controllable shutter zones corresponding to the plurality of different focal zones, disposed optically adjacent the at least one lens; and
applying a control signal to a selected one or more of the independently controllable shutter zones to control a light transmission characteristic of the shutter zone.

18. The method of claim 17, comprising applying a predetermined voltage to the selected one or more of the independently controllable shutter zones.
